(19) United States
(12) Patent Application Publication
(10) Pub. No.: US 2011/0320255 A1
(43) Pub. Date: Dec. 29, 2011

(54) System and method for method for administering a website promotional code and ensuring integrity of same

(76) Inventors: Josef Gorowitz, Redondo Beach, CA (US); Scott Dudelson, Los Angeles, CA (US); Ron Leshem, Los Angeles, CA (US)

(21) Appl. No.: 12/803,532

(22) Filed: Jun. 29, 2010

(51) Int. Cl. G06Q 30/00

(52) U.S. Cl. 705/14.26

(57) ABSTRACT

The present invention provides a method of administering a promotional code that is used to earn incentives but is unable to be shared among individual users. A promotional code is generated and is placed on a website that is affiliated with or connected to a rewards redemption website, but when a user goes to this page the promotional code system of the present invention generates a new, unique randomized code that is different each time a page is refreshed.

The inventions disclosed herein, in general, relate to website marketing and reward redemption. More particularly, the inventions disclosed herein relate to the generation, collection and redemption of promotional codes via websites.

### BACKGROUND OF THE INVENTION

Promotional codes are found on websites connected to the party offering the promotion and other sites that aim to distribute promotional codes and discount coupons. Users of websites that offer or use promotional codes are currently able to share such codes freely among each other and apply a static code to earn incentives. This has been a problem because promotional codes in general are aimed at driving users to a specific location or web page to “earn” the promotional code for marketing purposes. This is also known as a “call to action.” When users share the code they are no longer required to go to a specific location to earn the code, in other words, they can use the code without having performed the “call to action” step.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

In a first embodiment, the present invention provides a method of administering a promotional code that is used to earn incentives but is unable to be shared among individual users. A promotional code is generated and is placed on a website that is affiliated with or connected to a rewards redemption website, but when a user goes to this page the promotional code system of the present invention generates a new, unique randomized code that is different each time a page is refreshed.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 is a diagram that illustrates a method of redeeming a promotional code in accordance with the present invention.

### DETAILED DESCRIPTION OF THE INVENTION

The present invention provides methods for preventing multiple uses of a website promotional code. Typically, but not necessarily, comprising providing a promotional code on an administrative website affiliated with a rewards redemption website. Those of skill in the art will understand that as used herein, website can refer to either a single website with multiple pages, or different websites connected via a hyperlink or the like. The sites may be “connected” in a literal sense, or merely connected via agreement between the owner of the administrative website and the redemption website, if in fact they are different entities. In accordance with the present invention, when an end user accesses the website containing the promotional code, a randomized code is generated, preferably using the promotional code, each time the administrative website is refreshed. For example, if the promotional code is 123ABC, the code is “randomized” in accordance with the present invention when additional characters are added to the code, for example 123ABC@$@$@$. The additional characters may be a prefix, a suffix (as shown) or interspersed in the original character string that formed the “base” promotional code. In accordance with certain aspects of the present invention, the additional characters can either be invisible, or in other embodiments they may be visible to the end-user. It is preferred, but not necessary, that a total of six characters are added to the “base” promotional code.

After the randomized code has been generated, it is entered into the rewards redemption website. Because of the nature of the additional characters, it is preferred that the code either be entered automatically after it is generated, or “pasted” by the end user. After the randomized code is entered, it is compared with a database of codes to determine if the randomized code has been previously used. If the code has been previously used, it is disallowed, but if it has never been sued, the promotional transaction proceeds, e.g., issuing a coupon, an account credit or other promotional reward. Thus, once a randomized code has been entered into the promotional website it cannot be used again.

In certain embodiments of the present invention, the step of providing a promotional code comprises placing the promotional code on a website that is linked to the rewards redemption website. In other embodiments, the code may be placed on other sites, provided via e-mail or even printed in a publication, broadcast, etc. and then manually entered. In certain embodiments, the system will limit the number of times a randomized code can be generated, either by limiting the total number of randomized codes, or setting a period of time during which of randomized codes are generated, such as by defining a start date and an expiration date during which randomized codes can be generated. Alternatively, both a total number limit and a time limit can be implemented.

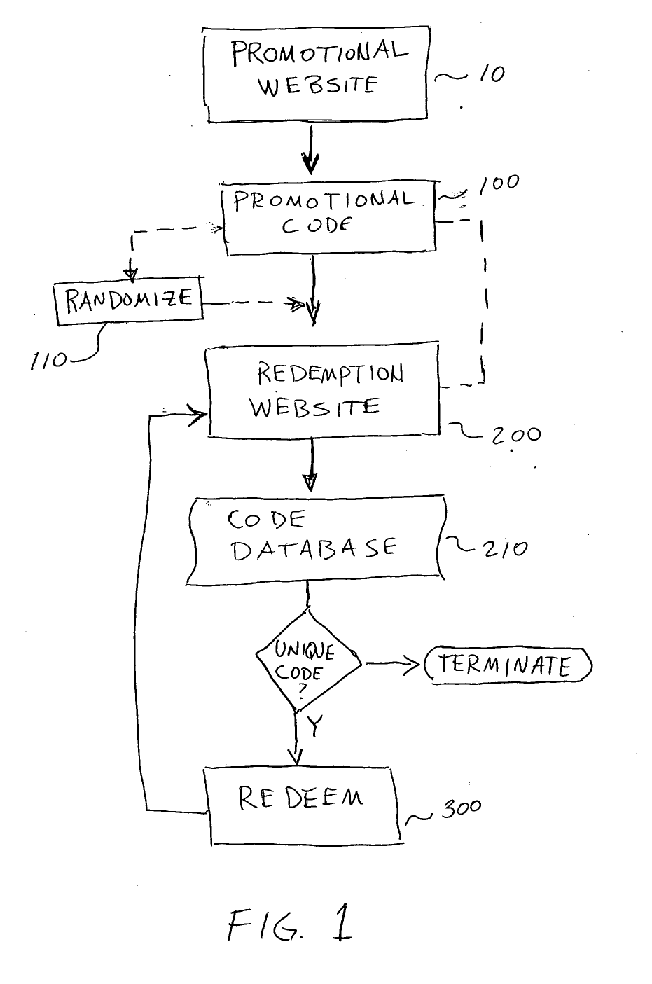

FIG. 1 illustrates method undertaken in accordance with the present invention. As illustrated, in a prefatory step 10 the user visits a promotional website, and is provided with a promotional code 100, however, the act of requesting a promotional code effects the step of randomizing the code 110, which, as explained above, preferably comprises adding additional characters to the “base” promotional code. The randomized code is then transferred to the redemption website 200, either directly or indirectly. Upon entry to the promotional website the code is checked via processing against a database 210 and it is determined if the randomized code has been used before. If the code is unique, that is, if it has not been used before, the redemption website 200 is authorized to redeem the incentive 300.

In accordance with one embodiment of the invention, a system is created running Java® script, is database driven and generates codes that are preferably instantly stored in a database controlled by the redemption administrator.

Administrative capabilities include the ability to limit how many codes we want to be used and how many we want exposed (meaning how many times a page will refresh with a random code being displayed), the start date and expiration date of the code. Each code has a base term (chosen by the administrator) and most preferably has six alphanumeric characters that are added to the end of the code. It is these six characters that are randomized and will change when the “base” code is exposed. Once a code is exposed and applied it can no longer be used again, as explained above and illustrated in FIG. 1. Each code will only expose one time, and by comparison against existing codes in a database will be disallowed if found to be a duplicate.

Additionally, it will be understood that the system of the present invention is able to “white list” specific sites that can host and expose the javascript code. Sites that are not on this white list are unable to reproduce the exposures and therefore this piece of code cannot be shared or pulled off a website using the present invention.

The present invention therefore provides a method that prevents users and other publishers from stealing and distributing promotional codes. We've also now ensured that in order to obtain a promotional code a user is linked to a web page chosen by the redemption administrator.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed is:

1. A method for preventing multiple uses of a website promotional code, comprising the steps of:
providing a promotional code on administrative website affiliated with a rewards redemption website;
generating a randomized code from the promotional code each time the administrative website is refreshed;
entering the randomized code into the rewards redemption website;
comparing the randomized code with a database of codes to determine if the randomized code has been used previously,
whereby once a randomized code is entered into the promotional website it cannot be used again.

2. The method of claim 1, wherein the step of providing a promotional code comprises placing the promotional code on a website that is linked to the rewards redemption website.

3. The method of claim 1, wherein the step of generating and comparing the randomized code comprises running Java® script and a database to generate codes that are instantly stored in a database controlled by a redemption administrator.

4. The method of claim 1, further comprising the step of limiting the number of times the step of generating a randomized code can be conducted.

5. The method of claim 4, whereby the step of limiting comprises limiting the total number of randomized codes.

6. The method of claim 4, whereby the step of limiting comprises limiting the time during which of randomized codes are generated.

7. The method of claim 1, further comprising defining a start date and an expiration date of a randomized code.

8. The method of claim 1, wherein the step of generating a randomized code comprises adding one or more characters to the promotional code.

9. The method of claim 8, wherein the step of adding characters comprises adding six characters.

10. The method of claim 8, wherein the step of adding characters comprises adding characters that are not visible to an end user of the promotional website.

11. A method for preventing multiple uses of a website promotional code, comprising the steps of: generating a randomized code from a promotional code; entering the randomized code into a rewards redemption website; comparing the randomized code with a database to determine if the randomized code has been used previously, whereby a previously used randomized code is entered into the promotional website it cannot be used again.

12. The method of claim 11, wherein the step of generating a randomized code comprises adding alphanumeric characters to an existing code.

13. The method of claim 12, wherein the alphanumeric characters are invisible to an end user.

14. The method of claim 12, wherein the alphanumeric characters are visible to an end user.
